(19) United States
(12) Patent Application Publication
(10) Pub. No.: US 2009/0158249 A1
(43) Pub. Date: Jun. 18, 2009

(54) SYSTEM AND METHOD FOR TESTING A SOFTWARE MODULE

(76) Inventors: Andrew Tomkins, San Jose, CA (US); Shanmugasundaram Ravikumar, Berkeley, CA (US); Randolph Preston McAfee, San Marino, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 11/955,997

(22) Filed: Dec. 13, 2007

(51) Int. Cl. G06F 9/44

(52) U.S. Cl. 717/107

(57) ABSTRACT

Systems and methods are described for testing a software module. The method comprises receiving a modified software module for use as part of a software application which includes a plurality of constituent software modules, replacing at least one of the constituent software modules with the modified software module to generate a modified software application, generating output data as a function of execution of the modified software application, and storing the output data.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to testing a software module. More specifically, embodiments of the present invention relate to inserting one or more new or modified software modules into (or removing one or more existing modules from) a software application comprising a plurality of software modules to determine an effect of the new, modified or removed module(s) on output, performance or usability of the software application.

### BACKGROUND OF THE INVENTION

When developing new applications, modules, patches, etc., software developers typically use software development kits (“SDK”), which provide development platforms and tools that allow a developer to build applications from scratch and test these applications in simulated environments. That is, even if the developer is only concerned with a particular feature of the application (e.g., the user interface), the entire application must be built in order to test the feature. Alternatively, the developer may gather and assemble different parts of the application from a variety of sources. Compatibility issues inevitably arise, however, which may adversely effect operation of the software or operation of the various components when used in combination. Thus, operation of the software may not be accurately judged if the developer cannot confirm that its performance is unhindered by, for example, compatibility issues.

Therefore, there exists a need for an environment in which a software module may be tested and its performance accurately measured and evaluated. There also exists a need for a framework in which software developers may add, remove or edit the functionality of one or more software modules of an application.

### SUMMARY OF THE INVENTION

The present invention generally relates to systems, methods and computer program products for testing a software module. The method may comprise receiving a modified software module for use as part of a software application which includes a plurality of constituent software modules, replacing at least one of the constituent software modules with the modified software module to generate a modified software application, generating output data as a function of execution of the modified software application, and storing the output data.

The software application may be a network search engine and the modified software module may include at least one of a code construct, a code snippet, a media file, a patch and a plug-in. The software application may be hosted on a server and access to the software application may be restricted. Graphical representations of a given one of the plurality of constituent software modules may be displayed. When replacing the at least one constituent software modules, the at least one of the constituent software modules may be identified as a function of a predetermined attribute. The predetermined attribute may include at least one of (i) an indication that a given one of plurality of constituent software modules has been modified, (ii) a functionality of the modified module, (iii) a name of the modified module and (iv) a size of the modified module.

The modified software module may be one of a web crawler, a document processing module, a corpus processing module, an indexing module, a matching module, a ranking module, a presentation module and an advertisement-delivery module. The output data may include at least one of (i) data indicative of output of the modified software application, (ii) data indicative of output of at least one of the modified software module and at least one of the constituent software modules and (iii) data generated by a user of the modified software application.

The output data may be at least one of raw data, a report, a summary, a table and a graph. The output data may be generated by computing at least one metric value as a function of operation of at least one of the modified software module and at least one of the constituent software modules and comparing the at least one metric value to at least one benchmark value. The at least one benchmark value may be a value generated during operation of the software application.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 shows an exemplary embodiment of a system for testing a software module according to one embodiment of the present invention; and

FIG. 2 shows an exemplary embodiment of a method for testing a software module according to one embodiment of the present invention.

### DETAILED DESCRIPTION OF THE EMBODIMENTS

In the following description of the embodiments of the invention, reference is made to the accompanying drawings that form a part hereof, and in which is shown by way of illustration exemplary embodiments in which the invention may be practiced. It is to be understood that other embodiments may be utilized and structural changes may be made without departing from the scope of the present invention.

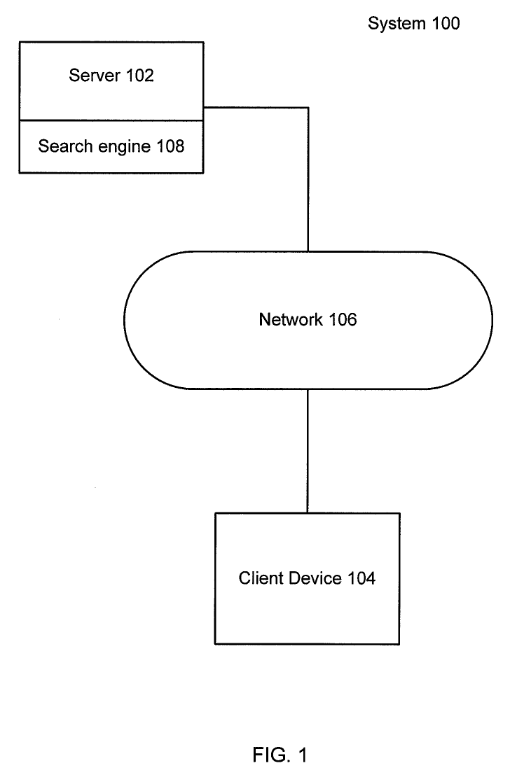

FIG. 1 shows an exemplary embodiment of a system 100 for testing a software module according to the present invention. The system 100 may comprise a server 102 and a client device 104 which are communicatively interconnected via a communications network 106 (e.g., a wired/wireless LAN/WAN, a cellular network, the Internet, an intranet, a VPN, a PSTN, etc.). The server 102 and the client device 104 may be processor-based computing devices which include memory and network connection ports for communicating data on the network 106. For example, the client device 104 may be a PC, laptop, mobile phone, PDA, tablet computer, handheld computer, etc. which utilizes a web browser (or command-line interface) for allowing a user to interface with devices on the network 106. Those of skill in the art understand that any number of client devices 104 may be connected to the network 106 and that the server 102 may comprise any number of servers and/or databases.

In the exemplary embodiment, the server 102 may host an application comprising a plurality of modules. For example, the application may be a web search engine 108, which may include various modules including, but not limited to, a crawler module, a document processing module, a corpus processing module, an indexing module, a matching module, a ranking module, a presentation module, etc. The various modules may correspond to various functions of the search engine 108. As understood by those of skill in the art, the search engine 108 may be used to classify or otherwise index content items accessible over the network 106 and respond to search queries from users by providing search results that identify those content items that are responsive thereto. The modules work in conjunction to execute the corresponding functions for performing tasks associated with, for example, locating the content items, classifying the content items and assembling the search results responsive to the queries.

While the exemplary embodiment is described with reference to the search engine 108, those of skill in the art understand that the application may be any stand-alone or network-based application, an embedded application, a server-side application, a client-side application, etc. Any of these exemplary applications may utilize a plurality of modules. Further, those of skill in the art recognize that the modules may be, for example, executables, code constructs, bytecode, code snippets, media files, patches, plug-ins, etc. which are utilized by the application.

The search engine 108 may operate in an online environment, such as the Internet, in which the search engine 108 periodically locates new or relocated content items and removes references to content items that the search engine 108 can no longer locate. When using the modules in an online environment, the user can be assured that the modules are operating to return the search results that represent available content items most relevant to the query. Those of skill in the art understand, however, that the present invention may be utilized in an offline environment or a stand-alone system. As an example of the former, the application may be downloaded to the client device 104 over the network 106 (e.g., from the server 102) for use locally on the client device 104. As an example of the latter, the application (which may comprise program code) may be stored on a computer-readable medium (e.g., magnetic media, CD, DVD, dongle, etc.) for local installation and use on the client device 104.

According to the exemplary embodiments of the present invention, a user may create a modified application by inserting a new module into an existing application in place of an existing module, inserting the new module into the existing application to be used with the existing modules, modifying an existing module (to create a modified module) substituting the modified module into the existing application or removing an existing module from the existing application. As understood by those of skill in the art, a developer may create, modify or remove more than one module to generate the modified application.

An impact of the change by the user to the application may be measured by executing the modified application and generating output data indicative of the operation of the modified application. For example, the output data may include application output data indicative of overall output or performance of the modified application. For example, when the modified application is a modified version of the search engine 108, the application output data may include a list of search results returned by the search engine 108. According to other exemplary embodiments, the output data may include module output data indicative of an operation of each (or selected ones) of the modules in the modified application. In these exemplary embodiments, metrics may be computed during execution of the modified application and compared to benchmark values corresponding to the metrics during execution of the unmodified application. Thus, the user may be apprised of the effect of the new, modified or removed module on output or performance of the application.

In further exemplary embodiments, the output data may include manually-generated output in the form of, for example, a user scoring system (e.g., by way of a survey). These embodiments may be useful to rate, for example, user-friendliness of the modified application, aesthetic value of a graphical user interface media display, etc. Those of skill in the art understand that the output data may be generated in real-time, during execution of the modified application, or after execution. Furthermore, the output data may be in a form of raw data, reports, summaries, tables, graphs, etc.

The modified application may be executed online (e.g., using network resources) or offline in, for example, a test environment. As an example of the latter, a test platform program may be executed on the server 102 or the client 104 which generates the test environment and includes data, features, etc. necessary for the modified application to execute. The test platform program may also monitor operation of the modified application to generate the output.

In an exemplary embodiment, the output data may be transmitted to a server (e.g., the server 102) hosting the application or a data collection device (not pictured) on the network 106 so that other users and developers may review and analyze the output data. For example, if the output indicates that the metrics have surpassed (or been less than) a threshold value, the output may be automatically transmitted to a given user. Alternatively, the output data may selectively transmitted to the server 102 or data collection device by the user or upon the occurrence of a given event, e.g., where the modified application or one of its constituent modules surpasses or is less than a benchmark value. As understood by those of skill in the art, the server 102 (or a server farm, databases, etc.) may maintain a plurality of applications or versions thereof, which users may access by testing or use.

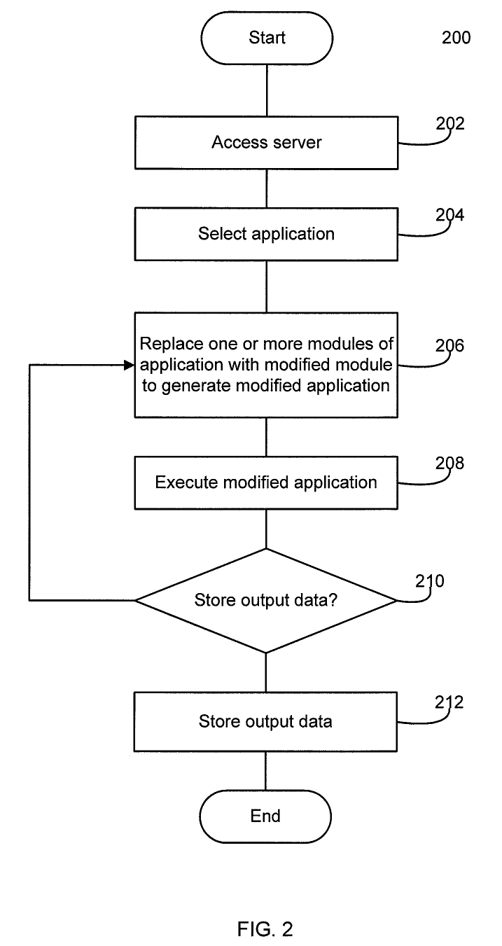

FIG. 2 shows an exemplary embodiment of a method 200 for testing a software module according to embodiments of the present invention. Although the exemplary embodiment of the method 200 is described with reference to a search engine, those of skill in the art understand that any software module, bytecode, class, function, code construct, code snippet, media file, patch, plug-in, etc., may be used and tested in the context of embodiments of the invention. Additionally, although the method 200 is described with reference to an online environment, those of skill in the art also understand that various stages of testing may be implemented in combinations of online or offline environments. Furthermore, the application may be tested in any environment using real or simulated data (e.g., a live platform versus a test platform).

In step 202, a user accesses a server to locate the application. The user may have to provide authentication information (e.g., log-in, password, etc.) or other credentials to gain access to information contained on the server, other servers or data stores connected thereto. Additionally, different levels of access may be granted on the basis of the authentication information. For example, in an academic setting, an instructor may be granted full access (e.g., read-write-save permission) to his or her students' applications. A given student, on the other hand, may only be granted access to his or her application or the applications being used in a current course.

In step 204, the user selects the application. Those of skill in the art understand that the server 102 may host various applications and present an interface (e.g., graphical user interface or command-line) allowing the user to select one or more of the applications. The interface may display the selected application as comprising various modules. In the case of the search engine, the interface may display a tree-structure with the search engine as the root node and its constituent modules as leaf nodes, e.g., nodes that represent a crawler module, a document processing module, a corpus processing module, an indexing module, a matching module, a ranking module, a presentation module, etc. and the interconnection between the nodes.

In step 206, one or more of the modules in the application is replaced with a modified module to create a modified application. The user may create the modified application by inserting a new module into the existing application in place of an existing module, inserting the new module into the existing application to be used with the existing modules, modifying an existing module (to create a modified module) and substituting the modified module into the existing application, or removing an existing module from the existing application. As understood by those of skill in the art, more than one module may be created, modified or removed to generate the modified application. Modifying the existing module may include, for example, re-writing source code, using different compilation techniques, adjusting how/when/order features of the existing module are executed, etc. Replacing the existing module with the modified module may be done manually by the user or automatically by, for example, the server identifying the existing module based on attribute of the module (e.g., the user selection of the existing module, the functionality of the module, the module name/size, etc.) and replacing the existing module with the modified module. The server may also recompile or debug as needed, which may also be done by the user, e.g., on the client device.

In an exemplary embodiment, the user may modify or build a new crawler module to generate a modified crawler module for the search engine to utilize. The modified crawler may utilize a different initial list of URLs to visit, a different method of identifying hyperlinks in a located web page, a different method for visiting the identified hyperlinks, etc. In another exemplary embodiment, the modified crawler may utilize one or more modified policies including, but not limited to, (i) a modified selection policy to determine those web pages to select for download, (ii) a modified re-visit policy to determine when to check web pages for changes, (iii) a modified politeness policy to avoid overloading websites, (iv) a modified parallelization policy to coordinate with other crawlers distributed over the network, etc. The modified selection policy may impart, for example, a different prioritization scheme for selecting web pages for download, a restriction to certain MIME types (e.g., HTML pages only, etc.), a method of selecting web pages with similar content, etc. The modified re-visit policy may impart, for example, a different frequency with which to return to web pages previously downloaded. The modified politeness policy may impart, for example, a different frequency with which to make requests to a given server. The modified parallelization policy may impart, for example, a different method for assigning discovered URLs to different crawlers.

The user may also modify or build a new document processing module to generate a modified document processing module for the search engine to utilize. The modified document processing may include variations on tokenization, parsing, phrase extraction or classification algorithms or models. For example, a modified tokenization algorithm may categorize blocks of alphanumeric characters differently, use a different method of assigning meaning to the blocks, use a different scanner (e.g., vary characters acceptable for a token), use a different evaluator (e.g., different method of generating a value(s) based on the characters in the token), use a different set of regular expressions, etc. A modified parsing algorithm may process tokens in an input stream in a different manner, build a different data structure as a result of the token processing, utilize a different parser type (e.g., top-down, bottom-up), etc. A modified phrase extraction algorithm may utilize a different vocabulary or set of corresponding concepts, a different linguistic processor, a different machine learning algorithm for creating a domain ontology, etc. A modified classification model may utilize different regression functions, different loss functions, different machine learning algorithms, etc.

The user may also modify or build a new corpus processing module to generate a modified corpus processing module for use by the search engine. The modified corpus processing module may include variations on link analysis, community analysis, site-level processing or cross-page extraction algorithms or models. A variation on a link analysis algorithm may utilize, for example, different methods for computing weights of hyperlinked resources or assign different values reflecting an importance of certain hyperlinks. A variation on a community analysis algorithm may utilize, for example, different methods of computing centrality measures or assigning different values reflecting importance of nodes within a community. A variation on a site-level processing may, for example, assign a higher relative importance to preselected portions (e.g., pages, hyperlinks, content items, etc.) within a site.

The user may also modify or build a new indexing module to generate a modified indexing module for use by the search engine. The modified indexing module may include variations on an amount of payload that is input, a type or amount of compression utilized, a modification of a number or types of terms in a dictionary or a varied method of generating the dictionary.

The user may also modify or build a new matching module to generate a modified matching module for use by the search engine. The modified matching module may include variations on algorithms or models for use by the search engine for query processing or identifying content items within the corpus which may be included in or excluded from the search results.

The user may also modify or build a new ranking module to generate a modified ranking module for use by the search engine. The modified ranking module may utilize, for example, customized ranking functions, new features for ranking frameworks, specialized ranking functions, new ranking algorithms or models, as well as new metrics for optimizing a new or existing ranking function.

The user may also modify or build a new presentation module to generate a modified presentation module for use by the search engine. The modified presentation module may include various graphical or command line interfaces for displaying a query page, a network browsing page and/or a search results page. The modified presentation module may also allow a visitor to build a customized search page. Furthermore, the modified presentation module may allow for variations in the search results page by, for example, displaying the search results using different combinations of graphics, videos, page titles, URLs, etc. The modified presentation module may also be designed for vertical search engines, embedded search engines and/or combination products using the functionality of the search engine (e.g., geographic mapping functions in combination with the search results).

In another exemplary embodiment, the user-created module may be utilized in conjunction with the search engine. For example, the module may be utilized to show ads to a visitor at various stages of the search process, e.g., on the query page, on the search results page, etc. An advertisement module may utilize algorithms or models for selecting ads based on the query or the search results, for rotating the ads so that users are not seeing similar ads when inputting similar queries, for allowing owners to create ads, for allowing owners to bid on space in the GUI or time displayed, etc.

In step 208, the modified application is executed. During execution, the exemplary embodiments of the present invention may measure performance of the application or its associated modules (individually or in pre-selected groupings) to generate output data. The output data may include application output data indicative of overall output of the modified application. For example, when the modified application is a modified version of the search engine, the application output data may include, but is not limited to, a list of search results returned by the search engine. In other exemplary embodiments, the output data may include module output data indicative of operation of each (or selected ones) of the modules in the modified application. In these exemplary embodiments, metrics may be computed during execution of the modified application and compared to benchmark values corresponding to the metrics during execution of the unmodified application. Thus, the user may be apprised of the effect of the new, modified or removed module on the application.

In further exemplary embodiments, the output data may include manually-generated output in the form of, for example, a user scoring system (e.g., a survey). These embodiments may be useful to rate, for example, user-friendliness of the modified application, quality of resultant data, aesthetic value of a graphical user interface or media display, etc. Those of skill in the art understand that the output data may be generated in real-time, during execution of the modified application, or after execution and may be in a form of raw data, reports, summaries, tables, graphs, etc.

In step 210, a determination is made as to whether the output data is stored. In the online environment, when the output data is to be stored, the output data may be uploaded to a server for storage, step 212. For example, the output data may be published on a website operated by the operator of the search engine. In this manner, users may analyze the output data from various versions of the search engine and determine which version may be used to test the modified module. In the offline environment, the output data may be stored on the client device, step 212, and optionally uploaded to the server 102 at a later time.

As understood by those of skill in the art, the present invention may be utilized as a collaborative tool amongst an array of developers for building new applications. Accordingly, the present invention may include a method of determining co-ownership of a given application. In one exemplary embodiment, a given user may sign a consent form which indicates that any submitted or modified module is open-source and free to be modified by any other user. In another exemplary embodiment, users may sign an agreement to commercialize an application or selected modules and negotiate ownership rights and/or be assigned default ownership rights.

FIGS. 1 and 2 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for implementing a customizable software application, comprising:
receiving a modified software module for use as part of a software application, the software application including a plurality of constituent software modules;
replacing at least one of the constituent software modules with the modified software module to generate a modified software application;
generating output data as a function of execution of the modified software application; and
storing the output data.

2. The method according to claim 1, wherein the software application is a network search engine.

3. The method according to claim 1, wherein the modified software module includes at least one of a code construct, a code snippet, a media file, a patch and a plug-in.

4. The method according to claim 1, comprising hosting the software application on a network accessible server.

5. The method according to claim 1, comprising restricting access to the software application.

6. The method according to claim 1, comprising displaying graphical representations of one or more of the plurality of constituent software modules.

7. The method according to claim 1, wherein replacing comprises identifying at least one of the constituent software modules as a function of a predetermined attribute.

8. The method according to claim 1, wherein receiving the modified software module comprises receiving one of a web crawler, a document processing module, a corpus processing module, an indexing module, a matching module, a ranking module, a presentation module and an advertisement-delivery module.

9. The method according to claim 1, wherein generating output data comprises generating at least one of raw data, a report, a summary, a table and a graph.

10. The method according to claim 1, wherein generating comprises:
computing at least one metric value as a function of operation of at least one of the modified software modules and at least one of the constituent software modules; and
comparing the at least one metric value to at least one benchmark value to generate the output data.

11. The method according to claim 12, wherein the at least one benchmark value is a value generated during operation of the software application.

12. Computer readable media for execution by a programmable processor to execute a method for implementing a customizable software application, the computer readable media comprising:
program code for receiving a modified software module for use as part of a software application, the software application including a plurality of constituent software modules;
program code for replacing at least one of the constituent software modules with the modified software module to generate a modified software application;
program code for generating output data as a function of execution of the modified software application; and
program code for storing the output data.

13. The computer readable media according to claim 12, wherein the software application is a network search engine.

14. The computer readable media according to claim 12, wherein the modified software module includes at least one of a code construct, a code snippet, a media file, a patch and a plug-in.

15. The computer readable media according to claim 12, comprising program code for hosting the software application on a network accessible server.

16. The computer readable media according to claim 1, comprising program code for restricting access to the software application.

17. The computer readable media according to claim 12, comprising program code for displaying graphical representations of one or more of the plurality of constituent software modules.

18. The computer readable media according to claim 12, wherein the program code for replacing comprises program code for identifying at least one of the constituent software modules as a function of a predetermined attribute.

19. The computer readable media according to claim 12, wherein the program code for receiving the modified software module comprises program code for receiving one of a web crawler, a document processing module, a corpus processing module, an indexing module, a matching module, a ranking module, a presentation module and an advertisement-delivery module.

20. The computer readable media according to claim 12, wherein the program code for generating output data comprises program code for generating at least one of raw data, a report, a summary, a table and a graph.

21. The computer readable media according to claim 12, wherein the program code for generating comprises:
program code for computing at least one metric value as a function of operation of at least one of the modified software modules and at least one of the constituent software modules; and
program code for comparing the at least one metric value to at least one benchmark value to generate the output data.

22. The computer readable media according to claim 21, wherein the at least one benchmark value is a value generated during operation of the software application.
